(19) United States
(12) Patent Application Publication
(10) Pub. No.: US 2015/0161293 A1
(43) Pub. Date: Jun. 11, 2015

(54) DETERMINATION OF GEODETIC INTERACTIONS THROUGH PROJECTION ONTO AN AUXILIARY SPHERE

(71) Applicant: SPACECURVE, INC., Seattle, WA (US)

(72) Inventors: Hans-Martin Will, Seattle, WA (US); Brett Kleinschmidt, Seattle, WA (US)

(73) Assignee: SPACECURVE, INC., Seattle, WA (US)

(21) Appl. No.: 14/099,813

(22) Filed: Dec. 6, 2013

(51) Int. Cl. G06F 17/50

(52) U.S. Cl. CPC G06F 17/50

(57) ABSTRACT

Methods, computer-readable storage media, and apparatuses for determining interactions between geometric shapes on a geoid may be described. In embodiments, queries about geometric shapes on a geoid may be received. Various interaction tests, such as point-point or point-segment intersection tests, may be identified that need to be determined to satisfy the query. Points for the geometric shapes may be projected onto an auxiliary sphere that is associated with the geoid. The tests may be performed using these projected points, and from the results of these tests, a response may be provided to the query. Approximate computations, such as limited-precision CPU-based computations, may also be utilized to reduce computational complexity during test performance. An error value may be determined during performance of these tests, and, if the error value is greater than a pre-determined error bound, the test may be performed using higher-precision computations. Additional embodiments may be described and claimed.

### BACKGROUND

An increasing number of computing applications, existing both online and offline, perform computations using geographic data. Such applications may include, for example, mapping applications, GPS applications, surveying applications, as well as other applications. As part of their computations, such applications may need to determine interactions between geometric shapes. For example, a surveying application may need to determine at what points two parcels of land border each other. In another example, a mapping application may need to determine where a road shape intersects with a shape defining a city or town. While the need to perform such determinations is common, such determinations can be complex. This complexity is especially apparent when dealing with terrestrial Earth data (or other real planetary data), as the shapes, land, etc. may be subject to imperfections that may increase complexity.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the Figures of the accompanying drawings.

FIG. 1 is a diagram illustrating differences between a geoid and an auxiliary sphere.

FIG. 2 is a diagram illustrating a projection of a point on a geoid onto an auxiliary sphere, in accordance with various embodiments.

FIG. 3 is a block diagram illustrating examples of components and information flows of a geodetic interaction determination system, in accordance with various embodiments.

FIG. 4 illustrates an example process for determining interactions between geometric shapes on a geoid, in accordance with various embodiments.

FIG. 5 illustrates an example process for identifying interactions needed to respond to a geometric shape query, in accordance with various embodiments.

FIG. 6 is a diagram illustrating a point-segment intersection example, in accordance with various embodiments.

FIG. 7 is a diagram illustrating a segment-segment intersection example, in accordance with various embodiments.

FIG. 8 illustrates an example process for determining interactions on an auxiliary sphere, in accordance with various embodiments.

FIG. 9 illustrates an example process for performing sidedness tests using approximate computations, in accordance with various embodiments.

FIG. 10 illustrates an example computing environment suitable for practicing various aspects of the present disclosure, in accordance with various embodiments.

FIG. 11 illustrates an example storage medium with instructions configured to enable an apparatus to practice various aspects of the present disclosure, in accordance with various embodiments.

### DETAILED DESCRIPTION

Methods, computer-readable storage media, and apparatuses for determining interactions between geometric shapes on a geoid are described. In embodiments, queries about geometric shapes on a geoid may be received, such as from an application, by a geodetic interaction determination system. These queries may include operators about such interactions as intersection, overlapping, whether shapes are contained within one another, etc. In various embodiments, various interaction tests may be identified that need to be determined to satisfy the query. For example, one or more point-point or point-segment intersection tests may be identified. After these tests are identified, points for the geometric shapes may be projected onto an auxiliary sphere that is associated with the geoid. The tests may be performed using these projected points, and from the results of these tests, a response may be provided to the query. Additionally, in various embodiments, approximate computations, such as limited-precision CPU-based computations, may be utilized to reduce computational complexity during test performance. An error value may be determined during performance of these tests, and, if the error value is greater than a pre-determined error bound, the test may be performed using higher-precision computations. Additional embodiments and implementation details are described below.

In the following detailed description, reference is made to the accompanying drawings which form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C). The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

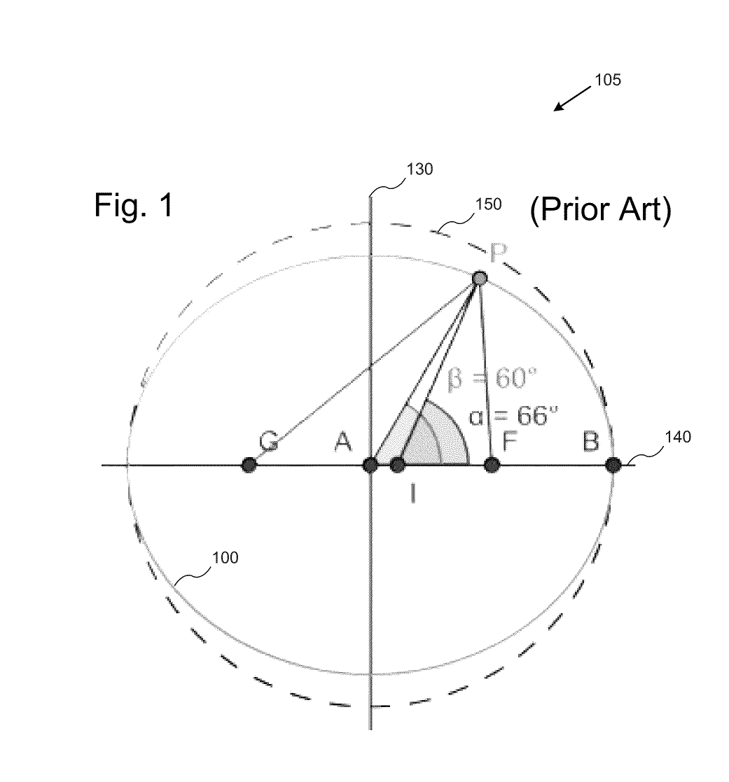

Referring now to FIG. 1, a diagram 105 illustrating differences between an example geoid and an auxiliary sphere is shown. As known in the prior art, a geoid 100 (shown in FIG. 1 in cross section) may be used to approximate a shape of a planet, such as, for example, Earth. A non-spherical geoid, such as geoid 100 may be used because the Earth (or another planetary surface) may not be best approximated by a spherical surface 150 (also illustrated in cross section). In the particular example of the Earth, the Earth may be approximated by a geoid 100 that is oblate spheroid, which may be an ellipse that is rotated around its polar axis. Similar to an ellipse, the geoid 100 may be able to be described with reference to its major and minor axes (140 and 130, respectively). In the example of FIG. 1, the example ellipse defining the geoid 100 is defined by foci F and G.

In addition to differences in shape, the sphere 150 and geoid 100 may differ in the way that points on the surface of the geoid are represented. For example, a latitude measurement may be taken for a point P, on the surface of the geoid. In various embodiments, the latitude of the point P may be determined by calculating the angle between a line normal to the surface of the geoid at point P (e.g., the line between I and P) and the equatorial plane (e.g., the plane defined by the sweep of the major axis 140 as the ellipse of the geoid 100 is rotated about the minor axis 130). Using this description of the latitude, point P may be seen to have a latitude of α=66°. It may be noted, however, that the line between points P and I does not intersect the equatorial plane at the center of the geoid A, as it might in a sphere. Indeed, if a line is drawn between the center and the point P and that line is used to determine a “geocentric latitude”, a different angle β=60° is observed. Further, other differences between the geoid 100 and sphere 150 may be observed.

It may be noted, however, that, while particular calculations may be understood well on a sphere and may be computed with lesser computational overhead than on other surfaces, these calculations may not translate directly to the surface of a geoid. For example, on a sphere, a line segment (referred to hereinafter as a “segment” for ease of description) connecting two points may define a great circle, which itself defines a plane through the center of the sphere. By contrast, a segment connecting two points on the geoid 100 may describe a line known as a geodesic, which may not be a great circle. As such, computations between segments and points on a geoid may be unable to rely on planar intersection computations that would be available for computations on a sphere. These properties of the geoid 100 may complicate calculations for determining interactions on the geoid.

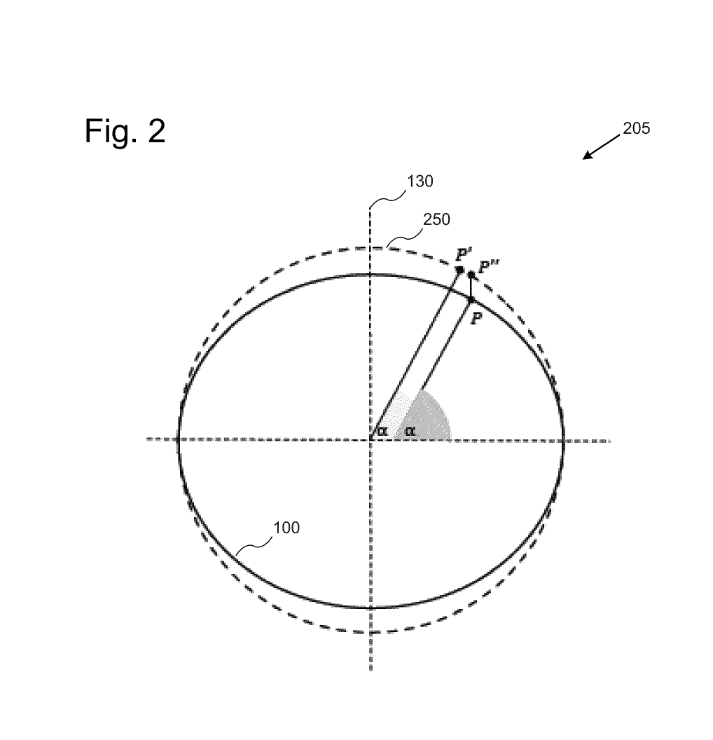

In order to simplify these determinations, techniques used herein may rely on projection of points on the geoid to the surface of an auxiliary sphere associated with the geoid. Referring now to FIG. 2, a diagram 205 illustrating a projection of a point P on a geoid 100 onto an auxiliary sphere 250 is illustrated in accordance with various embodiments. In FIG. 2, the point P on the geoid 100 is projected onto a projected point P″ on the auxiliary sphere 250. In various embodiments, the auxiliary sphere 250 may be defined as a sphere that completely encloses the geoid 100. In various embodiments, the auxiliary sphere 250 may be the smallest such sphere that encloses the geoid 100. However, while an auxiliary sphere 250 that encloses the geoid 100 may be useful to understand the relationship between the geoid 100 and the auxiliary sphere 250, in other embodiments, the auxiliary sphere 250 may be of a different size. For example, in some embodiments, the auxiliary sphere 250 may be a unit sphere of radius 1; in other embodiments, other sized spheres may be used.

In various embodiments the point P is projected onto the projected point P″ by projecting the point P along the minor axis of the geoid 130. It may be noted that a different point, P′, may be determined through use of a geocentric latitude equal to the geodetic latitude of the original point P (the example latitude being α). In various embodiments, this geocentric latitude-determined point P′ may not be used as the projection of P onto the auxiliary sphere 250. In various embodiments, if a segment includes multiple points, these points themselves may be projected onto the auxiliary sphere 250 in order to project the segment onto the auxiliary sphere 250.

In various embodiments, projection of the point P onto the projected point P″ using projections along the minor axis 130 may provide computational benefits over using the point P on the geoid directly. In particular, in various embodiments, such projections to the auxiliary sphere 250 may be continuous and may retain intersection relationships, such as point-segment intersections and segment-segment intersections, as described herein.

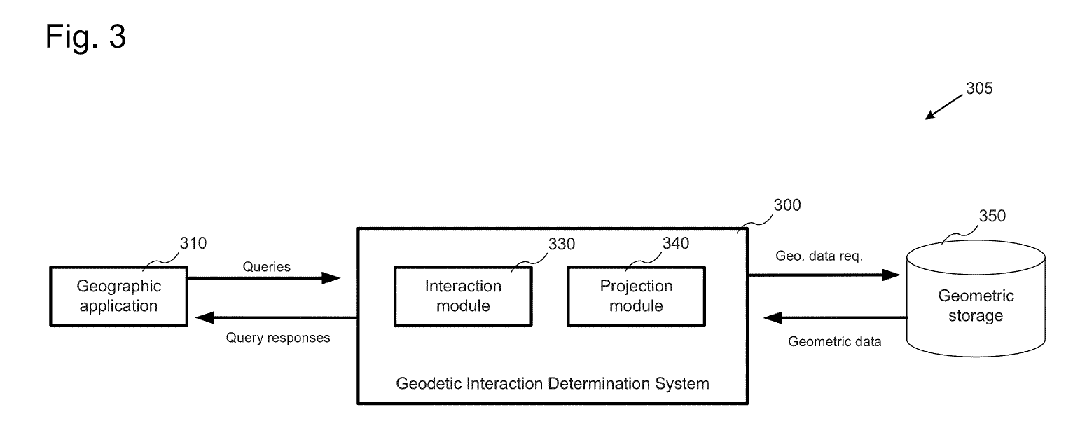

Referring now to FIG. 3 a block diagram 305 illustrates examples of components and information flows of a geodetic interaction determination system 300 (“GIDS 300”), in accordance with various embodiments. While particular entities and information flows are illustrated in FIG. 3, in various embodiments, modules and/or other entities illustrated in FIG. 3 may be merged, separated into additional entities, and/or omitted entirely.

As illustrated in FIG. 3, a geographic application 310 (“GA 310”) may communicate with the GIDS 300. In various embodiments, the GA 310 may include mapping software, GPS software, surveying software, and/or other applications. In various embodiments, the GA 310 may be configured to send one or more queries to the GIDS 300, and may receive one or more query responses in return. In various embodiments, these queries may include database queries, such as, for example, queries in the SQL language (or an extension thereof) or in other query languages. In various embodiments, the queries may include queries concerning interactions between geometric shapes on the geoid 100. In various embodiments, these shapes may include points, segments, and/or polygons on the geoid 100. In various embodiments, the segments and/or polygons may themselves be defined using points on the geoid, such as in a segment being defined by two points on the geoid, and a segment string or a polygon being described by a series of points on the geoid.

In various embodiments, the GIDS 300 may be configured to respond to queries from the GA 310 that utilize a particular set of interaction operators. The set of interaction operators may be constructed to represent common interactions between geometric shapes. The following table provides example interaction operators that may be supported by various embodiments described herein.

| Interaction Operator | Description |
|---|---|
| INTERSECTS (P, Q) | P intersects Q when their topological |
| | intersection is a non-empty set. |
| DISJOINT (P, Q) | P is disjoint from Q when they have no point |
| | in common. |
| CONTAINS (P, Q) | P contains Q when no points of Q lie in the |
| | exterior of P, and at least one point of the |
| | interior of Q lies in the interior of P. |
| WITHIN (P, Q) | P is within Q when P lies in the interior of Q. |
| EQUALS (P, Q) | P equals Q when their interiors intersect and |
| | no part of the interior or boundary of one |
| | intersects the exterior of the other. May not |
| | imply that they have the same vertices or |
| | even that they are of the same class. |
| TOUCHES (P, Q) | P touches Q when they have at least one |
| | boundary point in common, but no interior |
| | points. |
| OVERLAPS (P, Q) | P overlaps Q when they have some but not |
| | all interior points in common and their |
| | boundaries do not intersect. |
| CROSSES (P, Q) | P crosses Q when they have some but not all |
| | interior points in common and their |
| | boundaries intersect. |

In various embodiments, the GIDS 300 may include an interaction module 330 (“IM 330”) which may be configured to receive one or more queries from the GA 310 and, in response, to provide responses to the queries. The IM 330 may be configured, in various embodiments, to perform a conversion from interaction operators in the query into one or more intersection and/or equality tests, as described below. In various embodiments, the IM 330 may also be configured to perform the one or more intersection tests, as described below. In various embodiments, the IM 330 may be configured to perform the one or more intersection test using approximate computations, as described below.

In various embodiments, the GIDS 300 may also include a projection module 340 (“PM 340”), which may be configured to calculate projections of points describing geometric shapes on the geoid 100 onto the auxiliary sphere 250. In various embodiments, the PM 340 may be configured to make requests for geometric data describing such geometric shapes to an associated geometric storage 350 (“GS 350”). The GS 350, in various embodiments, may or may not be included as a portion of the GIDS 300; in some embodiments, the GS 350 may be a separate storage, and/or may be under control of a separate entity than the GIDS 300, such as if the GS 350 is owned or otherwise controlled by a governmental agency or other entity. In various embodiments, the GS 350 may provide one or more points on the geoid 100 describing geometric shapes to the PM 340. In turn, the PM 340 may project those points onto the auxiliary sphere 250 and may provide those projected points to the IM 330 for determination of interactions between the geometric shapes.

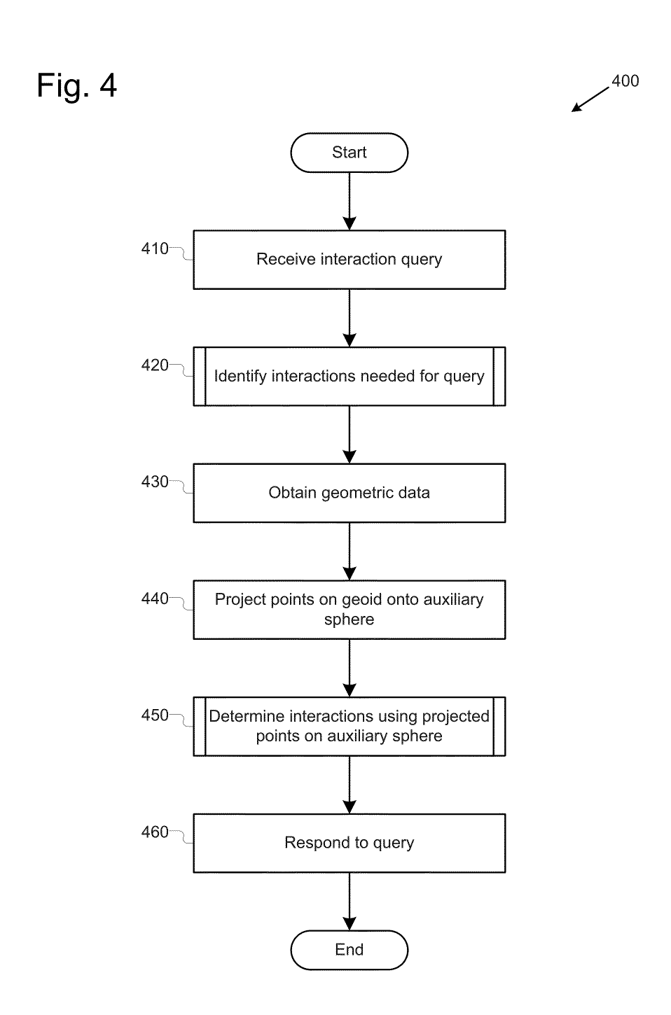

FIG. 4 illustrates an example process 400 for determining interactions between geometric shapes on the geoid 100, in accordance with various embodiments. While FIG. 4 illustrates particular example operations for process 400, in various embodiments, process 400 may include additional operations, omit illustrated operations, and/or combine illustrated operations. In various embodiments, process 400 may be performed by one or more entities of the GIDS 300.

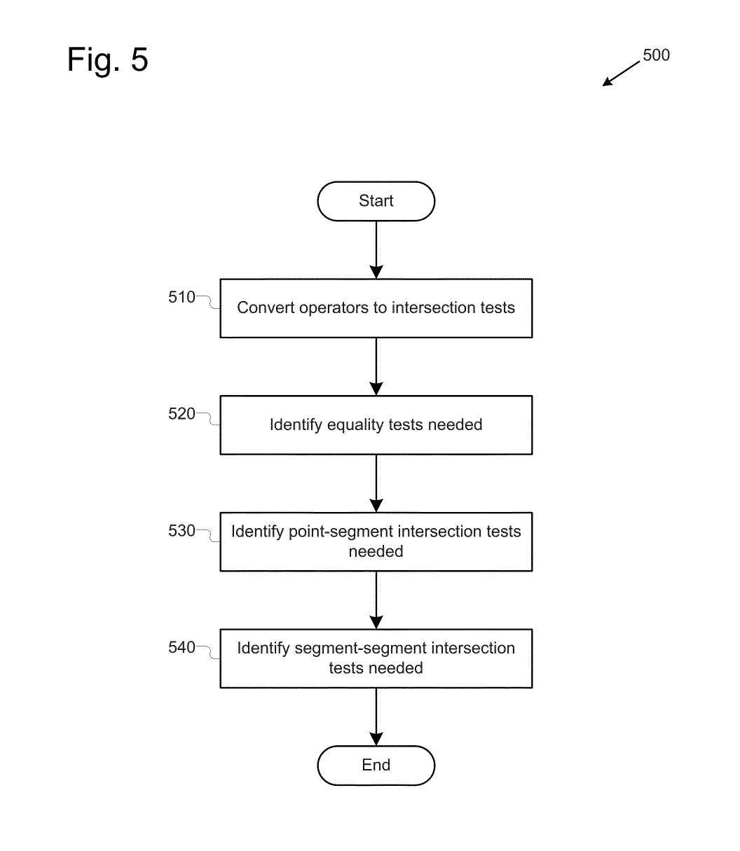

Process 400 may begin at operation 410, where the IM 330 of the GIDS 300 may receive a query requesting information about interactions between one or more geometric shapes on the geoid 100, such as from the GA 310. As discussed herein, the query may, in various embodiments, may include queries in the SQL, or other database language, or in an extension of a database query language. Next, at operation 420, the IM 330 of the GIDS 300 may identify one or more interactions needed to determine the query. In various embodiments, at operation 420, the IM 330 may determine one or more intersection and/or equality tests that may be performed in order to respond to the query. Particular examples of embodiments of operation 420 are described below with reference to process 500 of FIG. 5. Next, at operation 430, the PM 340 of the GIDS 300 may obtain geometric data, such as through request to the GS 350. At operation 440, the PM 340 may project one or more points on the geoid 100 onto the auxiliary sphere 250. In various embodiments, the PM 340 may project a coordinate (X, Y, Z″) on the geoid onto coordinate (X, Y, Z″) on the auxiliary sphere 250 using the following equation for the Z″ coordinate:

Z″=sgn(Z)sqrt(R²−X²−Y²),

where R is the radius of the auxiliary sphere 250, sgn(Z) is the signum of Z, and sqrt denotes the square root function.

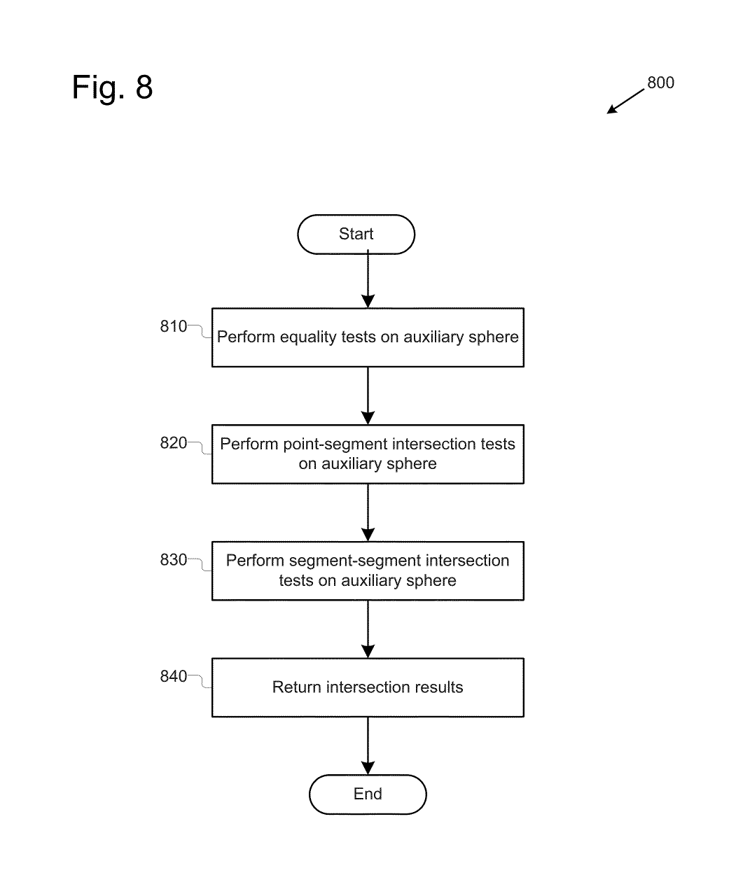

Next, at operation 450, the IM 330 may determine the interactions between the geometric shapes from the query, such as based on the previously identified interactions. Particular examples of embodiments of operation 450 are described below with reference to process 800 of FIG. 8. Next, at operation 460, the IM 330 may respond to the query. The process may then end.

FIG. 5 illustrates an example process 500 for identifying interactions needed to respond to a geometric shape query, in accordance with various embodiments. Process 500 may include implementations of operation 420 of process 400 of FIG. 4. While FIG. 5 illustrates particular example operations for process 500, in various embodiments, process 500 may include additional operations, omit illustrated operations, and/or combine illustrated operations. In various embodiments, aspects of process 500 may be performed by the IM 330 of the GIDS 300.

The process may begin at operation 510, where the IM 33 may convert operators in the query into intersection tests. In various embodiments, this conversion may be performed using the 9-Intersection Model, which may be referred to as “DE-9IM”. This model may expresses each of the spatial operators in terms of intersection tests between the interior (I), boundary (B) or exterior (E) of each of the geometries that are being compared. The definitions of interior, boundary and exterior may follow common mathematical convention. For example, the boundary of a polygon may be a set of segments delineating its area, the inside may be the enclosed area without the boundary, and the exterior may be the surrounding area, again excluding the boundary itself. For a segment, the two vertices may form its boundary and the connecting segment without those end-points may form the interior. For a single point, the point may be considered to have itself as interior, with no boundary, and with the complement of the point on the geoid as the exterior. Using DE-9IM notation, operation 510 may be performed through performance of intersection tests between the Interior, Exterior, and Boundaries of each of the two shapes.

For example, DE-9IM may prescribe a 3-by-3 matrix, where each element may corresponds to the characteristic function of a pairwise intersection of interior, boundary or exterior of two objects:

$$NIM ( P , Q ) = ( \begin{matrix}[ I ( P ) ⋂ I ( Q ) \neq φ ] & [ I ( P ) ⋂ B ( Q ) \neq φ ] & [ I ( P ) ⋂ E ( Q ) \neq φ ] \\ [ B ( P ) ⋂ I ( Q ) \neq φ ] & [ B ( P ) ⋂ B ( Q ) \neq φ ] & [ B ( P ) ⋂ E ( Q ) \neq φ ] \\ [ E ( P ) ⋂ I ( Q ) \neq φ ] & [ E ( P ) ⋂ B ( Q ) \neq φ ] & [ E ( P ) ⋂ E ( Q ) \neq φ ]\end{matrix} )$$

The operators described above may then be broken down into the following notational matrices

| Interaction Operator | DE-9IM Matric |
|---|---|
| INTERSECTS (P, Q) | Any matrix with at least one entry with a |
| | value of 1. |
| DISJOINT (P, Q) | $NIM ( P , Q ) = ( \begin{matrix}0 & 0 & 1 \\ 0 & 0 & 1 \\ 1 & 1 & 1\end{matrix} )$ |
| CONTAINS (P, Q) | $NIM ( P , Q ) = ( \begin{matrix}1 & 1 & 1 \\ 0 & * & 1 \\ 0 & 0 & 1\end{matrix} )$ |
| WITHIN (P, Q) | $NIM ( P , Q ) = ( \begin{matrix}1 & 0 & 1 \\ 1 & * & 1 \\ 1 & 1 & 1\end{matrix} )$ |
| EQUALS (P, Q) | $NIM ( P , Q ) = ( \begin{matrix}1 & 0 & 0 \\ 0 & 1 & 0 \\ 0 & 0 & 1\end{matrix} )$ |
| TOUCHES (P, Q) | $NIM ( P , Q ) = ( \begin{matrix}0 & 0 & 1 \\ 0 & 1 & 1 \\ 1 & 1 & 1\end{matrix} )$ |
| OVERLAPS (P, Q) | $NIM ( P , Q ) = ( \begin{matrix}1 & 1 & 1 \\ 1 & 1 & 1 \\ 1 & 1 & 1\end{matrix} )$ |
| CROSSES (P, Q) | $NIM ( P , Q ) = ( \begin{matrix}1 & 1 & 1 \\ 1 & 0 & 1 \\ 1 & 1 & 1\end{matrix} )$ |

Once the interactions have been converted to intersection tests the IM 330 may identify the various tests needed. Thus, at operation 520, the IM 330 may identify equality tests that are needed. For example, if a query includes an operator asking whether two points are equal, or whether a point P crosses a segment Q, the IM 330 may identify that it should perform a test as to whether the point P and an end point of Q are equal.

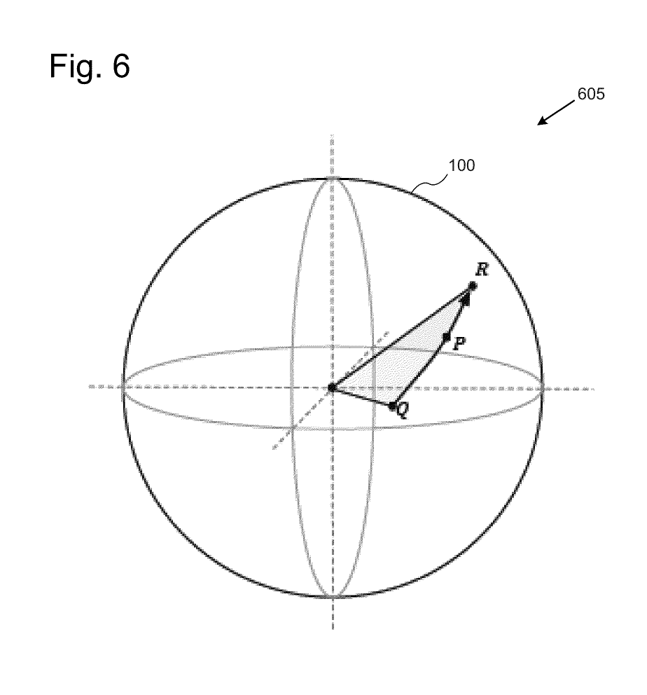

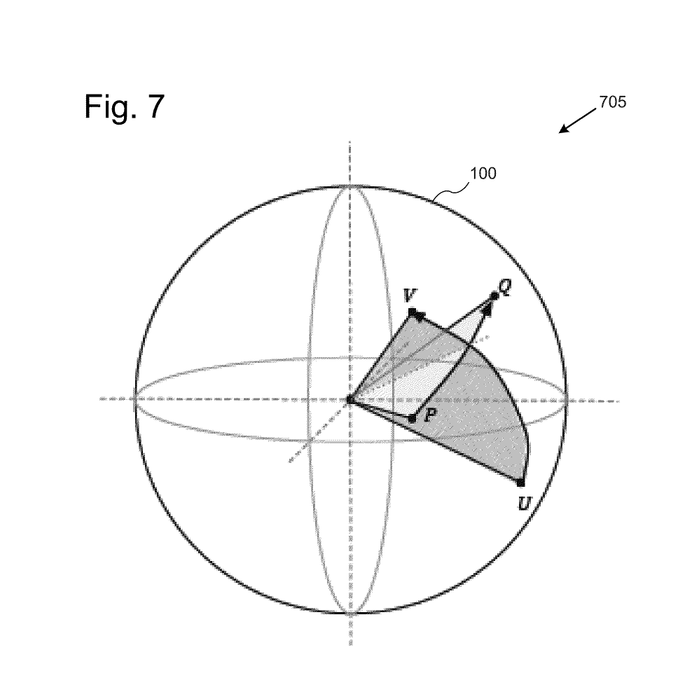

Next, at operations 530, the IM 330 may identify point-segment intersections that are needed. For example, referring now to FIG. 6, a diagram 605 illustrates a point-segment intersection example, in accordance with various embodiments. In the example, a point P is intersecting a segment between points Q and R. Next, at operation 540, the IM 330 may identify segment-segment intersections that are needed. For example, referring now to FIG. 7, a diagram 705 illustrates a segment-segment intersection example, in accordance with various embodiments. In the example, a segment between points U and V is intersecting a segment between points P and Q. It may be noted in both examples of FIGS. 6 and 7, that the segments are illustrated with a direction from their first and second points. This direction additionally may, in various embodiments, facilitate the idea of “sidedness,” that is, which side of the segment a point may fall on. Tests for sidedness may be utilized in various embodiments of performances of point-segment and segment-segment intersection tests, as may be described below. After operation 540, the process may end.

FIG. 8 illustrates an example process 800 for determining interactions on an auxiliary sphere, in accordance with various embodiments. Process 800 may include implementations of operation 450 of process 400 of FIG. 4. While FIG. 8 illustrates particular example operations for process 800, in various embodiments, process 800 may include additional operations, omit illustrated operations, and/or combine illustrated operations. In various embodiments, aspects of process 800 may be performed by the IM 330 of the GIDS 300. In various embodiments, process 800 may be performed through operation of the following pseudo code, which determines interactions between two geometries G and H, where G and H are polygonal geometric shapes. It may be noted that the “Segments-Cross” procedure is described in greater detail below. It may also be noted in particular that the “Point-Segment-Intersection” and “Segments-Cross” procedures may be respectively identified by the IM 330 as point-segment intersection and segment-segment intersection test for later performance.

```
procedure Intersects(G, H):
    procedure Point-In-Polygon(P, G):
        O := a point outside of G
        w := 0
        for each segment AB in G:
            if Segments-Cross(P, O, A, B):
                w := w + 1
        if w is odd:
            return “interior”
        else
            return “empty”
for each segment AB in G:
    for each segment CD in H:
        if Point-Segment-Intersection(A, C, D) ≠ { “empty” }:
            return true
        if Point-Segment-Intersection(C, A, B) ≠ { “empty” }:
            return true
        if Segment-Segment-Intersection(A, B, C, D) ≠ { “empty” }:
            return true
    for each vertex A in G:
    if Point-In-Polygon(A, H) != “empty”:
        return true
    for each vertex C in H:
        if Point-In-Polygon(C, G) != “empty”:
        return true
    return false
```

While an example of pseudo code is given for a particular intersection operator example, in other embodiments, other code may be used for various operators to identify equality test, point-segment tests, and segment-segment tests.

Referring again to FIG. 8, process 800 may begin at operation 810, where the IM 330 may perform one or more equality tests on projected points on the auxiliary sphere. In various embodiments, these quality tests may include point-point tests, segment-segment tests, and/or shape-shape tests. In various embodiments, regardless of the tests, the equality tests may be performed by directly comparing one or more projected points on the auxiliary sphere to see if they are at substantially identical coordinates. In various embodiments, points may be considered to be at substantially identical coordinates if they are within a pre-determined distance from each other.

Next, at operation 820, the IM 330 may perform point-segment intersection tests on the auxiliary sphere. In various embodiments, a point-segment intersection test (as well as segment-segment intersection tests) may be determined through computation of a “sidedness test” for a projected point P and a segment defined by projected points Q and R on the auxiliary sphere. In such a test, the following values may represent particular orientations of the point P in relation to the segment:
1) A value of 1 may indicate that P is located to the left of the great circle through Q and R on the auxiliary sphere.
2) A value of −1 may indicate that P is located to the right of the great circle through Q and R on the auxiliary sphere.
3) A value of 0 may indicate that P is located on the great circle through Q and R on the auxiliary sphere.

In various embodiments, the sidedness test may be computed by determining a signum of a determinant formed over the coordinates of the projected points P, Q, and R:

$$⊙ ( P , Q , R ) = sgn \vert \begin{matrix}{P}_{x} & {Q}_{x} & {R}_{x} \\ {P}_{y} & {Q}_{y} & {R}_{y} \\ {P}_{z} & {Q}_{z} & {R}_{z}\end{matrix} \vert$$

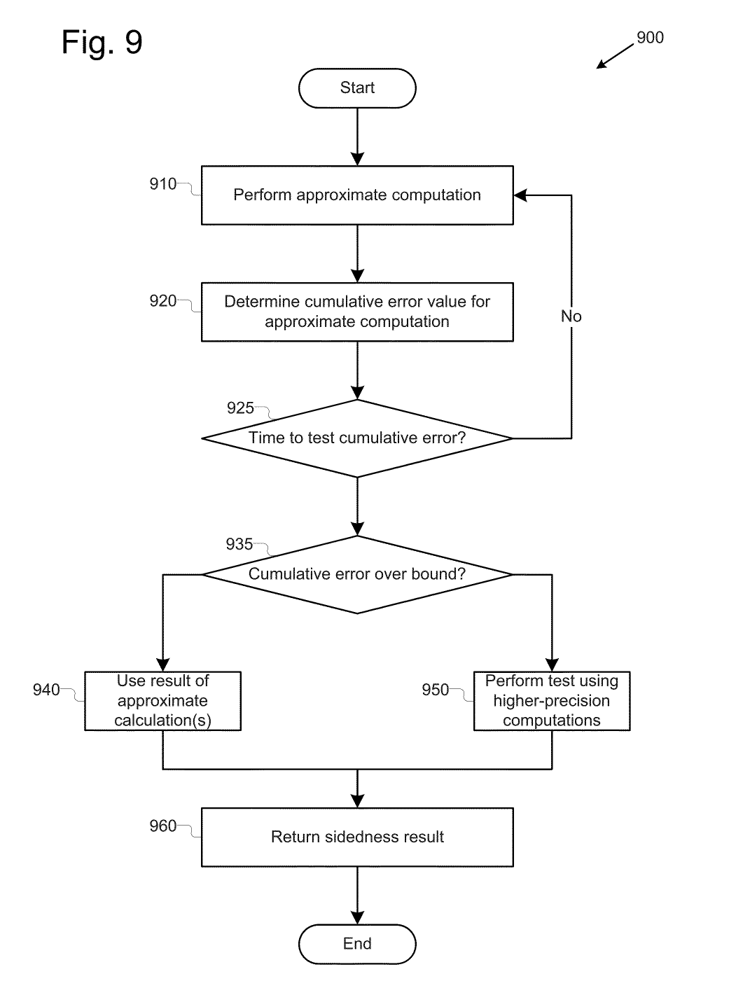

The determinant and sign function may be computed mathematically as understood by one of ordinary skill. Particular techniques for performing the sidedness test using approximate computations are described below with reference to process 900 of FIG. 9.

Using the Sidedness function described above, at operation 820, the IM 330 may perform a point-segment intersection test using a procedure described by the following pseudo code for a point P and a segment defined by points Q and R:

```
procedure Point-Segment-Intersection(P, Q, R):
    T := a point not on the geodesic containing QR
    if P = Q or P = R:
        return { “boundary” }
    if ⊙ P,Q, R = 0 and ⊙ (Q, T, P) ≠ ⊙ (R, T, P) :
        return { “interior” }
    else:
    return { “empty” }
```

Next, at operation 830, the IM 330 may perform segment-segment intersection tests on the auxiliary sphere. In various embodiments, the IM 330 may perform a segment-segment intersection test using a procedure described by the following pseudo code for a point P and a segment defined by points Q and R:

```
procedure Segment-Segment-Intersection(P, Q, R, S):
    procedure Segments-Cross(P, Q, R, S):
        return (⊙ (P,Q, R) > 0) ≠ (⊙ (P,Q, S) > 0) and
        (⊙ (R, S, P) > 0) ≠ (⊙ (R, S,Q) > 0)
            I_PRS := Point-Segment-Intersection (P, R, S)
            I_QRS := Point-Segment-Intersection (Q, R, S)
            if I_PRS = { “boundary” } AND I_QRS = { “boundary”}:
                return { “boundary”, “interior” }
            if I_PRS ≠ { “empty” } AND I_QRS ≠ { “empty” }:
                return I_PRS ∪ I_QRS
            I_RPQ := Point-Segment-Intersection (R, P, Q)
            I_SPQ := Point-Segment-Intersection (S, P, Q)
            if I_RPQ ≠ { “empty” } AND I_SPQ ≠ { “empty” }:
                return I_RPQ ∪ I_SPQ
            if Segments-Cross(P, Q, R, S):
                return { “interior” }
            else
                return { “empty” }
```

Next, at operation 840, the IM 330 may return the intersection rest results so that the IM 330 may respond to the query from the GA 310. The process may then end.

FIG. 9 illustrates an example process 900 for performing sidedness tests using approximate computations, in accordance with various embodiments. In various embodiments, process 900 may be performed in order to utilize approximate computations that may provide speed or other resource benefits over higher-precision computations. For example, the IM 330 may utilize arithmetic instructions of a CPU instead of arbitrary-precision software-based computations, in order to improve response time when performing many sidedness tests. However, because these approximate computations may introduce error, in various embodiments, an error value is calculated and compared to an error bound to check for an unacceptably high error. It may be noted that, in various embodiments, the process of FIG. 9 may be used for determinations other than the sidedness test described above.

The process may begin at operation 910, where the IM 330 may perform an approximate computation, such as using arithmetic instructions on a CPU. Next, at operation 920, the IM 330 may determine a cumulative error value. The cumulative error value may include an estimate of error that is believed to have been introduced by use of approximate computations.

Next, at decision operation 925, the IM 330 may determine whether it is time to test the cumulative error value. In various embodiments, the IM 330 may only determine that it is time to test the cumulative error when the determinant of the sidedness test has been finally computed. In other embodiments, the IM 330 may determine to test the error at one or more points before final computation of a sidedness test. If, at decision operation 925, the IM 330 determines it is not time to test the cumulative error, then the process may return to operation 910 for additional approximate computation.

If, however, at decision operation 925, the IM 330 determines it is time to test the cumulative error, then at decision operation 935, the IM 330 may determine if the cumulative error is over an error bound. In various embodiments, the IM 330 may make such a determination by comparing the cumulative error to the value of the determinant computed during the computation of the sidedness test. In other embodiments, a different dynamic or static error bound value may be compared to the cumulative error value at decision operation 935. After the comparison, if the IM 330 determines that the cumulative error value is less than the error bound, then at operation 940, the IM 330 may use the already-computed result of the approximate calculation(s). If, however, the cumulative error value is higher than the error bound, then at operation 950, the IM 330 may perform the text using higher-precision computations, such as arbitrary-precision software computations. In either event, at operation 960, the IM 330 may return the result of the performed sidedness test, and the process may end.

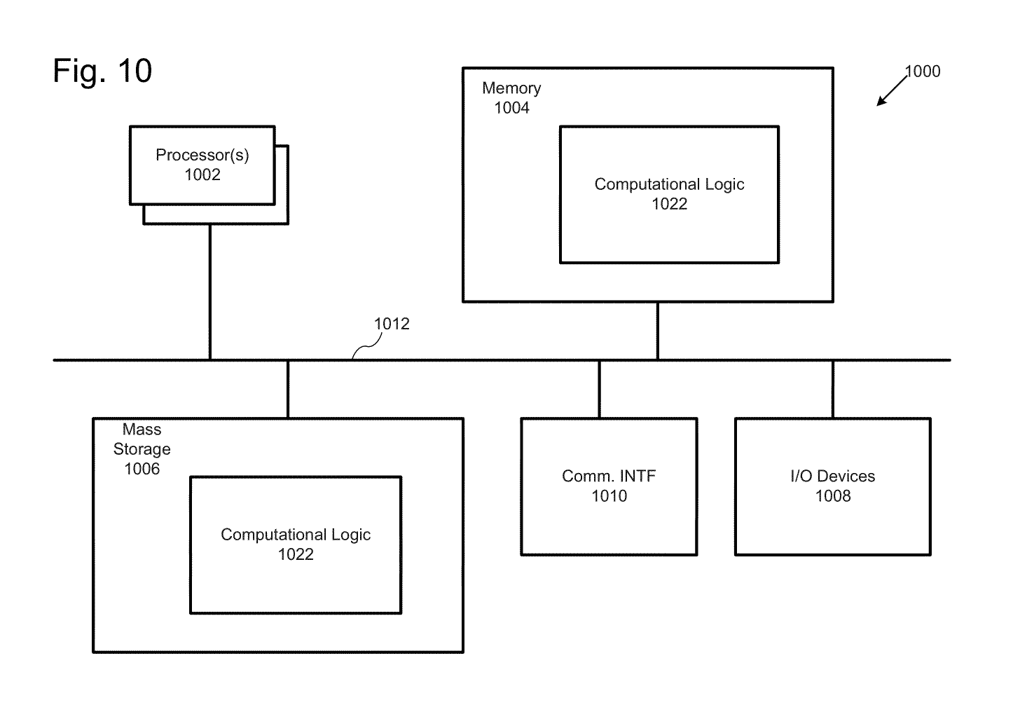

Referring now to FIG. 10, an example computer suitable for practicing various aspects of the present disclosure, including processes of FIGS. 4, 5, 8, and 9, is illustrated in accordance with various embodiments. As shown, computer 1000 may include one or more processors or processor cores 1002, and system memory 1004. For the purpose of this application, including the claims, the terms “processor” and “processor cores” may be considered synonymous, unless the context clearly requires otherwise. Additionally, computer 1000 may include mass storage devices 1006 (such as diskette, hard drive, compact disc read only memory (“CD-ROM”) and so forth), input/output devices 1008 (such as display, keyboard, cursor control, remote control, gaming controller, image capture device, and so forth) and communication interfaces 1010 (such as network interface cards, modems, infrared receivers, radio receivers (e.g., Bluetooth), and so forth). The elements may be coupled to each other via system bus 1012, which may represent one or more buses. In the case of multiple buses, they may be bridged by one or more bus bridges (not shown).

Each of these elements may perform its conventional functions known in the art. In particular, system memory 1004 and mass storage devices 1006 may be employed to store a working copy and a permanent copy of the programming instructions implementing the operations associated with GIDS 300, e.g., operations associated with geometric shape interaction determination, collectively referred to as computing logic 1022. The various elements may be implemented by assembler instructions supported by processor(s) 1002 or high-level languages, such as, for example, C, that can be compiled into such instructions.

The permanent copy of the programming instructions may be placed into permanent storage devices 1006 in the factory, or in the field, through, for example, a distribution medium (not shown), such as a compact disc (“CD”), digital versatile disc, (“DVD”), or through communication interface 1010 (from a distribution server (not shown)). That is, one or more distribution media having an implementation of the agent program may be employed to distribute the agent and program various computing devices.

The number, capability and/or capacity of these elements 1010-1012 may vary. Their constitutions are otherwise known, and accordingly will not be further described.

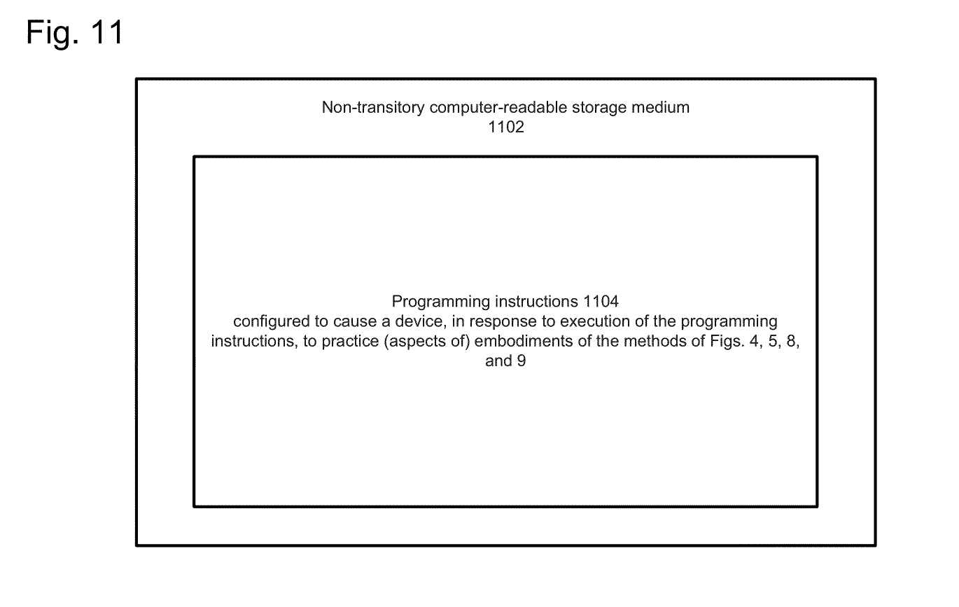

FIG. 11 illustrates an example least one non-transitory computer-readable storage medium 1102 having instructions configured to practice all or selected ones of the operations associated with GIDS 300, e.g., operations associated with geometric shape interaction determination, earlier described, in accordance with various embodiments. As illustrated, the at least non-transitory one computer-readable storage medium 1102 may include a number of programming instructions 1104. Programming instructions 1104 may be configured to enable a device, e.g., computer 1000 and/or GIDS 300, in response to execution of the programming instructions, to perform, e.g., various operations of processes of FIGS. 4, 5, 8, and 9, e.g., but not limited to, to the various operations performed to perform geometric shape interaction determination. In alternate embodiments, programming instructions 1104 may be disposed on multiple non-transitory one computer-readable storage media 1102 instead.

Referring back to FIG. 10, for one embodiment, at least one of processors 1002 may be packaged together with memory having computational logic 1022 configured to practice aspects of processes of FIGS. 4, 5, 8, and 9. For one embodiment, at least one of processors 1002 may be packaged together with memory having computational logic 1022 configured to practice aspects of processes of FIGS. 4, 5, 8, and 9 to form a System in Package (“SiP”). For one embodiment, at least one of processors 1002 may be integrated on the same die with memory having computational logic 1022 configured to practice aspects of processes of FIGS. 4, 5, 8, and 9. For one embodiment, at least one of processors 1002 may be packaged together with memory having computational logic 1022 configured to practice aspects of processes of FIGS. 4, 5, 8, and 9 to form a System on Chip (“SoC”). For at least one embodiment, the SoC may be utilized in, e.g., but not limited to, a computing tablet.

Computer-readable media (including least one computer-readable media), methods, apparatuses, systems and devices for performing the above-described techniques are illustrative examples of embodiments disclosed herein. Additionally, other devices in the above-described interactions may be configured to perform various disclosed techniques.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein. Therefore, it is manifestly intended that embodiments described herein be limited only by the claims.

Where the disclosure recites “a” or “a first” element or the equivalent thereof, such disclosure includes one or more such elements, neither requiring nor excluding two or more such elements. Further, ordinal indicators (e.g., first, second or third) for identified elements are used to distinguish between the elements, and do not indicate or imply a required or limited number of such elements, nor do they indicate a particular position or order of such elements unless otherwise specifically stated.

What is claimed is:

1. A method for determining interactions between one or more geometric shapes on a geoid, the method comprising:
projecting, by a computing device, one or more points and one or more line segments of the one or more geometric shapes onto one or more projected points and one or more projected line segments on an auxiliary sphere associated with the geoid; and
determining, by the computing device, interactions between the geometric shapes on the geoid by determining one or more interactions between the one or more projected points or the one or more projected line segments on the auxiliary sphere.

2. The method of claim 1, wherein determining interactions between the one or more projected points or one or more projected line segments comprises determining one or more intersections between the one or more projected points and one or more projected line segments.

3. The method of claim 2, wherein determining one or more intersections between the one or more projected points and one or more projected line segments comprises performing one or more sidedness determinations between the one or more projected points and the one or more projected line segments.

4. The method of claim 1, wherein:
the one or more points of the one or more geometric shapes comprise one or more points on the geoid; and
projecting one or more points and one or more line segments of the one or more geometric shapes comprises:
determining one or more additional points on the geoid which define the one or more line segments; and
projecting the one or more points and one or more additional points on the geoid onto one or more points on the auxiliary sphere.

5. The method of claim 4, wherein:
the geoid is described by a major and a minor axis; and
projecting the one or more points on the geoid onto one or more points on the auxiliary sphere comprises projecting the one or more points from the geoid onto the auxiliary sphere along the minor axis.

6. The method of claim 1, wherein determining one or more interactions between the one or more projected points and the one or more projected line segments comprises determining the one or more interactions based on one or more approximate computations.

7. The method of claim 6, wherein determining the one or more interactions based on one or more approximate computations comprises, for a determination of an interaction:
performing one or more approximate computations for the determination of the intersection;
calculating an error value for the approximate computations; and
when the error value is greater than an error bound, performing one or more higher-precision computations in lieu of the one or more approximate computations.

8. The method of claim 7, wherein:
the one or more approximate computations comprise arithmetic instructions performed in hardware on a computing processor; and
the one or more higher-precision computations comprise performance of arbitrary-precision software functions.

9. The method of claim 1, wherein the one or more line segments comprise boundary line segments for the one or more geometric shapes on the geoid.

10. The method of claim 1, wherein the one or more points comprise interior points for one or more of the geometric shapes.

11. An apparatus for determining interactions between one or more geometric shapes on a geoid, the apparatus comprising:
one or more computing processors;
a projection module configured to operate on the one or more computing processors to project one or more points and one or more line segments of the one or more geometric shapes onto one or more projected points and one or more projected line segments on an auxiliary sphere surrounding the geoid; and
a shape interaction module configured to operate on the one or more computing processors to determine interactions between the geometric shapes on the geoid by being configured to determine one or more interactions between the one or more projected points or the one or more projected line segments on the auxiliary sphere.

12. The apparatus of claim 11, wherein determine interactions between the one or more projected points or one or more projected line segments comprises determine one or more intersections between the one or more projected points and one or more projected line segments.

13. The apparatus of claim 12, wherein determine one or more intersections between the one or more projected points and one or more projected line segments comprises perform of one or more sidedness determinations between the one or more projected points and the one or more projected line segments.

14. The apparatus of claim 11, wherein:
the one or more points of the one or more geometric shapes comprise one or more points on the geoid; and
project one or more points and one or more line segments of the one or more geometric shapes comprises:
determine one or more additional points on the geoid which define the one or more line segments; and
project the one or more points and one or more additional points on the geoid onto one or more points on the auxiliary sphere.

15. The apparatus of claim 14, wherein:
the geoid is described by a major and a minor axis; and
project the one or more points on the geoid onto one or more points on the auxiliary sphere comprises project the one or more points from the geoid onto the auxiliary sphere along the minor axis.

16. The apparatus of claim 11, wherein determine one or more interactions between the one or more projected points and the one or more projected line segments comprises determine the one or more interactions based on one or more approximate computations.

17. The apparatus of claim 16, wherein determine the one or more interactions based on one or more approximate computations comprises, for a determination of an interaction:
perform one or more approximate computations for the determination of the intersection;
calculate an error value for the approximate computations; and
when the error value is greater than an error bound, perform one or more higher-precision computations in lieu of the one or more approximate computations.

18. The apparatus of claim 17, wherein:
the one or more approximate computations comprise arithmetic instructions performed in hardware on a computing processor; and
the one or more higher-precision computations comprise performance of arbitrary-precision software functions.

19. The apparatus of claim 11, wherein the one or more line segments comprise boundary line segments for the one or more geometric shapes on the geoid.

20. The apparatus of claim 11, wherein the one or more points comprise interior points for one or more of the geometric shapes.

21. One or more non-transitory computer-readable media containing instructions written thereon that, in response to execution on a computing device, cause the computing device to determine interactions between one or more geometric shapes on a geoid by causing the computing device to:
project one or more points and one or more line segments of the one or more geometric shapes onto one or more projected points and one or more projected line segments on an auxiliary sphere associated with the geoid; and
determine interactions between the geometric shapes on the geoid by determining one or more interactions between the one or more projected points or the one or more projected line segments on the auxiliary sphere.

22. The one or more non-transitory computer-readable media of claim 21, wherein determine interactions between the one or more projected points or one or more projected line segments comprises determine one or more intersections between the one or more projected points and one or more projected line segments.

23. The one or more non-transitory computer-readable media of claim 22, wherein determine one or more intersections between the one or more projected points and one or more projected line segments comprises perform of one or more sidedness determinations between the one or more projected points and the one or more projected line segments.

24. The one or more non-transitory computer-readable media of claim 21, wherein:
the one or more points of the one or more geometric shapes comprise one or more points on the geoid; and
project one or more points and one or more line segments of the one or more geometric shapes comprises:
determine one or more additional points on the geoid which define the one or more line segments; and
project the one or more points and one or more additional points on the geoid onto one or more points on the auxiliary sphere.

25. The one or more non-transitory computer-readable media of claim 24, wherein:
the geoid is described by a major and a minor axis; and
project the one or more points on the geoid onto one or more points on the auxiliary sphere comprises project the one or more points from the geoid onto the auxiliary sphere along the minor axis.

26. The one or more non-transitory computer-readable media of claim 21, wherein determine one or more interactions between the one or more projected points and the one or more projected line segments comprises determine the one or more interactions based on one or more approximate computations.

27. The one or more non-transitory computer-readable media of claim 26, wherein determine the one or more interactions based on one or more approximate computations comprises, for a determination of an interaction:
perform one or more approximate computations for the determination of the intersection;
calculate an error value for the approximate computations; and
when the error value is greater than an error bound, perform one or more higher-precision computations in lieu of the one or more approximate computations.

28. The one or more non-transitory computer-readable media of claim 27, wherein:
the one or more approximate computations comprise arithmetic instructions performed in hardware on a computing processor; and
the one or more higher-precision computations comprise performance of arbitrary-precision software functions.

29. The one or more non-transitory computer-readable media of claim 21, wherein the one or more line segments comprise boundary line segments for the one or more geometric shapes on the geoid.

30. The one or more non-transitory computer-readable media of claim 21, wherein the one or more points comprise interior points for one or more of the geometric shapes.
